(19) United States
(12) Patent Application Publication
(10) Pub. No.: US 2026/0088594 A1
(43) Pub. Date: Mar. 26, 2026

(54) Fish Tape and Wire Pulling Tip

(71) Applicant: Milwaukee Electric Tool Corporation, Brookfield, WI (US)

(72) Inventors: Christian R. Braun, Milwaukee, WI (US); Kyle A. Ritz, Burlington, WI (US); Ryan S. Dauss, Milwaukee, WI (US); Claire A. Sigworth, Milwaukee, WI (US); Grace A. Carpenter, Milwaukee, WI (US); Travis L. Dusendang, Milwaukee, WI (US)

(21) Appl. No.: 19/331,492

(22) Filed: Sep. 17, 2025

Related U.S. Application Data
(60) Provisional application No. 63/698,845, filed on Sep. 25, 2024.

(51) Int. Cl. H02G 1/08

(52) U.S. Cl. CPC H02G 1/083; H02G 1/081

(57) ABSTRACT

Various embodiments of wire pulling tools are provided. In various embodiments, the wire pulling tools described herein facilitate users pulling fish tape through spaces, such as enclosed spaces. In various embodiments, the wire pulling tools described herein facilitate coupling one or more flexible elongate structures to a fish tape, thereby permitting one or more flexible elongate structures to be pulled through the selected space.

### CROSS-REFERENCE TO RELATED PATENT APPLICATION

The present application claims the benefit of and priority to U.S. Provisional Application No. 63/698,845 filed on Sep. 25, 2024, which is incorporated herein by reference in its entirety.

### BACKGROUND OF THE INVENTION

The present disclosure is directed generally to the field of hand tools. The present disclosure relates specifically to wire pulling tools.

### SUMMARY OF THE INVENTION

One embodiment of the invention relates to an apparatus for pulling multiple flexible elongate objects, the apparatus including a body extending along a longitudinal axis from a first end to a second end, the body defining an aperture extending through the body along the longitudinal axis, a threaded fastener, a threaded portion of the aperture including helical threads, the threaded portion configured to receive the threaded fastener that is received into the aperture at the second end of the body, and a first recess of the aperture configured to receive a first flexible elongate structure that is received into the aperture at the first end of the body. The threaded fastener is configured to interface against the first flexible elongate structure to bias the first flexible elongate structure from being removed from the body in a first direction when the body is being pulled in a second direction opposite the first direction.

Another embodiment of the invention relates to an apparatus for pulling multiple flexible elongate objects, the apparatus including a coupler and a first leader. The first leader includes a first body configured to receive a first flexible elongate structure, a first pulling ring configured to be coupled to the first body and detachably coupled to the coupler, and a first fastener configured to be coupled to the first body. The first fastener is configured to interface against the first flexible elongate structure to bias the first flexible elongate structure from being removed from the first body in a first direction when the first body is being pulled in a second direction opposite the first direction.

Another embodiment of the invention relates to an apparatus for pulling multiple flexible elongate objects, the apparatus including a chain including a plurality of links coupled together, and a flexible body configured to be circumferentially wrapped around the chain a plurality of times. One or more of the plurality of links define one or more apertures, and the one or more apertures are configured to receive one or more flexible elongate structures including a first flexible elongate structure. The flexible body is configured to interface against the first flexible elongate structure to bias the first flexible elongate structure from being removed from the chain in a first direction when the chain is being pulled in a second direction opposite the first direction.

Various embodiments of the invention relate to a tool such as a wire pulling tool, such as a fish tape. In specific embodiments, the wire pulling tool includes one or more features, such as a wire pulling tip, a lighted tip, a hanging hook and/or a digital distance display indicated the amount of fish tape paid out.

Additional features and advantages will be set forth in the detailed description which follows, and, in part, will be readily apparent to those skilled in the art from the description or recognized by practicing the embodiments as described in the written description included, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of an apparatus, according to an exemplary embodiment.

FIG. 2 is a perspective view of the apparatus of FIG. 1, according to an exemplary embodiment.

FIG. 3 is a perspective view of the apparatus of FIG. 1, according to an exemplary embodiment.

FIG. 4 is a perspective view of the apparatus of FIG. 1, according to an exemplary embodiment.

FIG. 5 is a perspective view of a portion of the apparatus of FIG. 1, according to an exemplary embodiment.

FIG. 6 is a perspective cross-section view of a portion of the apparatus of FIG. 1, according to an exemplary embodiment.

FIG. 7 is a perspective view of a portion of the apparatus of FIG. 1, according to an exemplary embodiment.

FIG. 8 is a perspective view of a portion of the apparatus of FIG. 1, according to an exemplary embodiment.

FIG. 9 is a perspective view of an apparatus, according to another exemplary embodiment.

FIG. 10 is a side view of a portion of the apparatus of FIG. 9, according to an exemplary embodiment.

FIG. 11 is a side view of a portion of the apparatus of FIG. 9, according to an exemplary embodiment.

FIG. 12 is a side view of a portion of the apparatus of FIG. 9, according to an exemplary embodiment.

FIG. 13 is a side view of a portion of the apparatus of FIG. 9, according to an exemplary embodiment.

FIG. 14 is a side view of a portion of an apparatus, according to another exemplary embodiment.

FIG. 15 is a side view of the apparatus of FIG. 14, according to an exemplary embodiment.

FIG. 16 is a side view of the apparatus of FIG. 14, according to an exemplary embodiment.

FIG. 17 is a side view of an apparatus, according to another exemplary embodiment.

FIG. 18 is a side view of the apparatus of FIG. 17, according to an exemplary embodiment.

FIG. 19 is a side view of the apparatus of FIG. 17, according to an exemplary embodiment.

FIG. 20 is a perspective view of an apparatus, according to another exemplary embodiment.

FIG. 21 is a side view of the apparatus of FIG. 20, according to an exemplary embodiment.

FIG. 22 is a side view of the apparatus of FIG. 20, according to an exemplary embodiment.

FIG. 23 is a side view of an apparatus, according to another exemplary embodiment.

FIG. 24 is a side view of the apparatus of FIG. 23, according to an exemplary embodiment.

FIG. 25 is a side view of the apparatus of FIG. 23, according to an exemplary embodiment.

FIG. 26 is a perspective view of an apparatus, according to another exemplary embodiment.

FIG. 27 is a perspective view of the apparatus of FIG. 26, according to an exemplary embodiment.

FIG. 28 is a side view of the apparatus of FIG. 26, according to an exemplary embodiment.

FIG. 29 is a side view of an apparatus, according to another exemplary embodiment.

FIG. 30 is a perspective view of an apparatus, according to another exemplary embodiment.

### DETAILED DESCRIPTION

Referring generally to the figures, various embodiments of a wire pulling tool are provided. In specific embodiments, the wire pulling tool includes a tip designed to securely engage a wire to be pulled. In specific embodiments, the wire pulling tool includes a lighted tip. In specific embodiments, the wire pulling tool is a fish tape and includes a hanging hook and/or a digital display that shows the length of fish tape paid out.

In various embodiments, the designs discuss herein are designed to improve user's experience when wire fishing and pulling, improve user's productivity and/or reduce the amount of time to setup/breakdown.

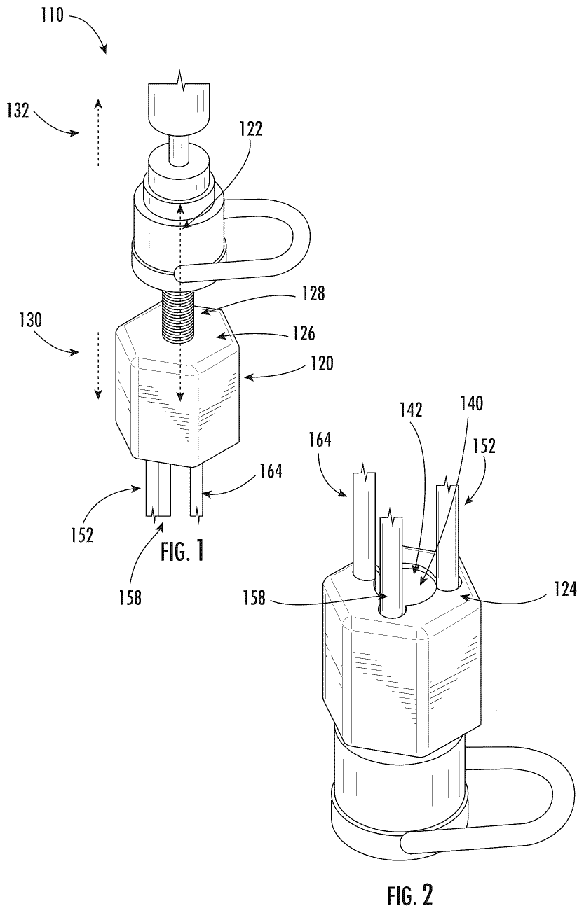

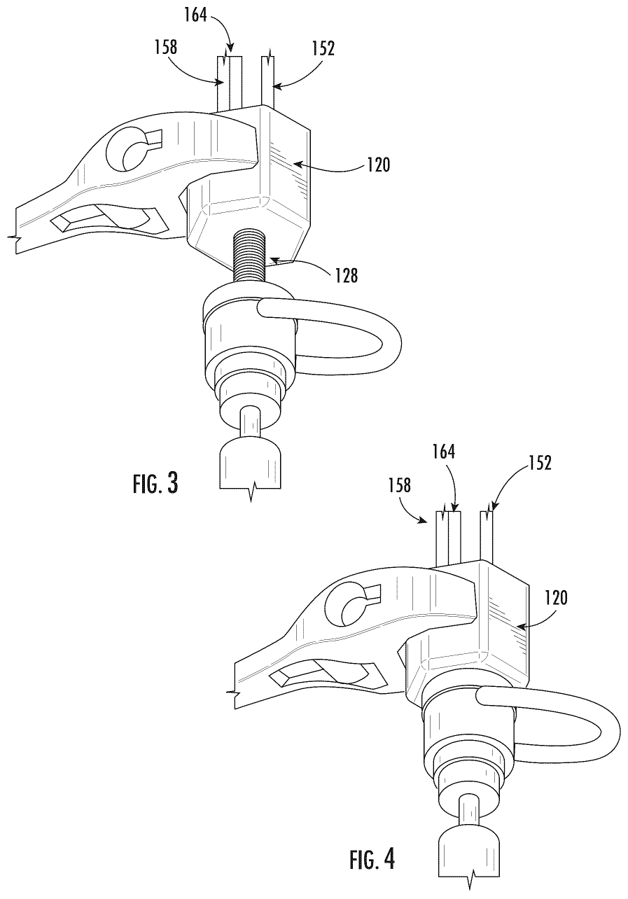

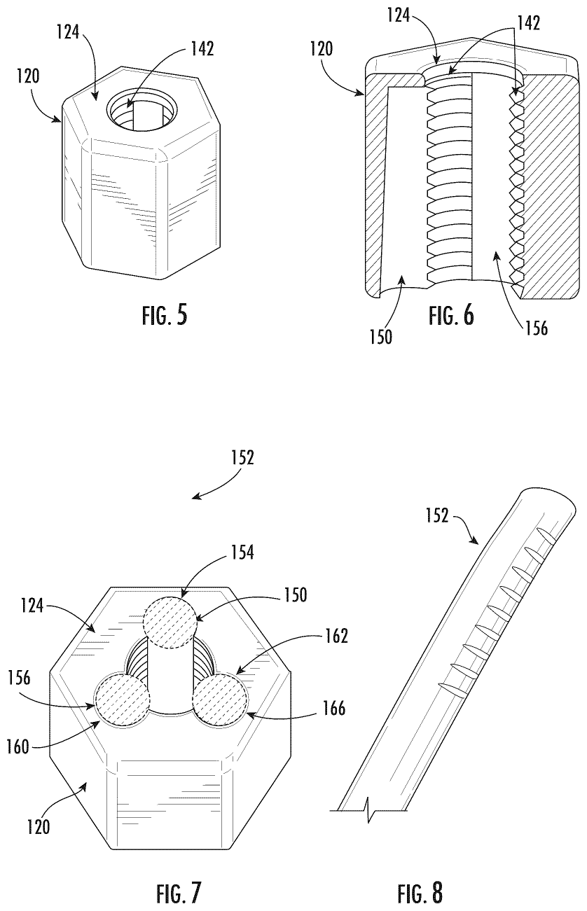

Referring to FIGS. 1-8, various aspects of apparatus 110 are provided. Apparatus 110 is configured to facilitate pulling one or more elongate structures, such as wires, through spaces, such as behind a dry wall and/or through a vent.

Apparatus 110 includes a body 120 extending along a longitudinal axis 122 from a first end 124 to a second end 126. Body 120 defines an aperture 140 extending through the body 120 along the longitudinal axis 122. Apparatus 110 further includes a threaded fastener 128, a threaded portion 142 of the aperture 140 including helical threads, the threaded portion 142 configured to receive the threaded fastener 128 that is received into the aperture 140 at the second end 126 of the body 120. Apparatus 110 further includes a first recess 150 of the aperture 140 configured to receive a first flexible elongate structure, shown as first wire 152, that is received into the aperture 140 at the first end 124 of the body 120. The threaded fastener 128 is configured to interface against the first wire 152 to bias the first wire 152 from being removed from the body 120 in a first direction 130 when the body 120 is being pulled in a second direction 132 opposite the first direction 130. As one example, after first wire 152 is engaged with body 120 via threaded fastener 128, a user pulls body 120 through a space, such as behind a drywall, to thereby extend first wire 152 through that space. In various embodiments, the threading of fastener 128 engages with first wire 152 to bias first wire 152 in second direction 132, such as via the threading of fastener 128 engaging within a cover of first wire 152 (see FIG. 8).

In various embodiments, the threaded portion 142 of the aperture 140 defines a cylinder extending through the body 120 along the longitudinal axis 122. In various embodiments, the cylinder is centrally located within the body 120.

In various embodiments, the first recess 150 is tapered in size such that a size 154 of the first recess 150 as measured perpendicularly to the longitudinal axis 122 decreases the further the first recess 150 is from the first end 124 of the body 120. In various embodiments, the size 154 of the first recess 150 as measured perpendicularly to the longitudinal axis 122 decreases linearly the further the first recess 150 is from the first end 124 of the body 120.

In various embodiments, apparatus 110 includes a second recess 156 of the aperture 140 configured to receive a second flexible elongate structure, shown as second wire 158, that is received into the aperture 140 at the first end 124 of the body 120. The threaded fastener 128 is configured to interface against the second wire 158 to bias the second wire 158 from being removed from the body 120 in the first direction 130 when the body 120 is being pulled in the second direction 132. In various embodiments, the second recess 156 is tapered in size such that a size 160 of the second recess 156 as measured perpendicularly to the longitudinal axis 122 decreases linearly the further the second recess 156 is from the first end 124 of the body 120.

In various embodiments, apparatus 110 includes a third recess 162 of the aperture 140 configured to receive a third flexible elongate structure, shown as third wire 164, that is received into the aperture 140 at the first end 124 of the body 120. The threaded fastener 128 is configured to interface against the third wire 164 to bias the third wire 164 from being removed from the body 120 in the first direction 130 when the body 120 is being pulled in the second direction 132. In various embodiments, the third recess 162 is tapered in size such that a size 166 of the third recess 162 as measured perpendicularly to the longitudinal axis 122 decreases linearly the further the third recess 162 is from the first end 124 of the body 120.

In various embodiments, the first recess 150, the second recess 156, and the third recess 162 are arranged symmetrically to each other with respect to the longitudinal axis 122.

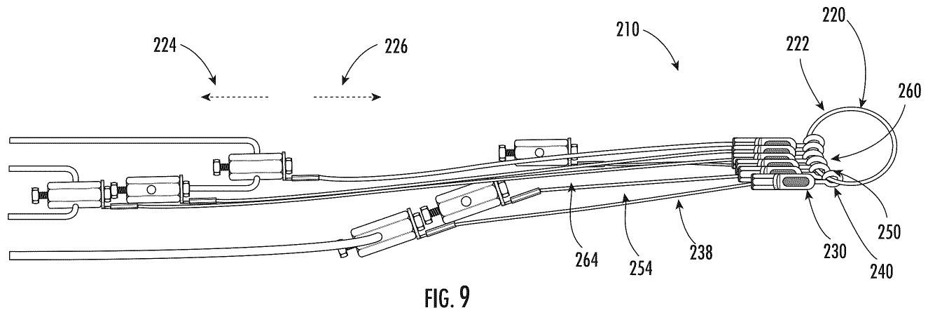

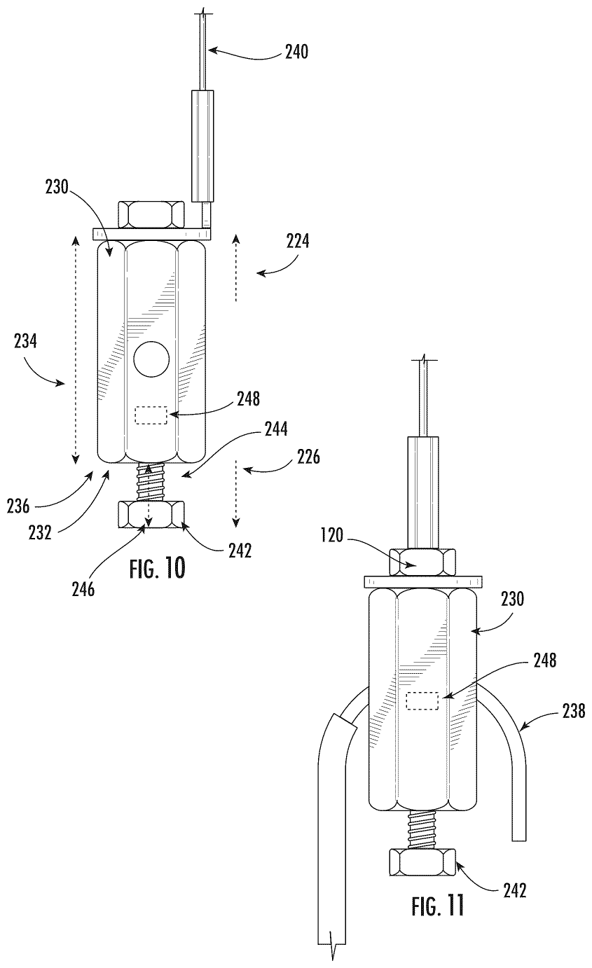

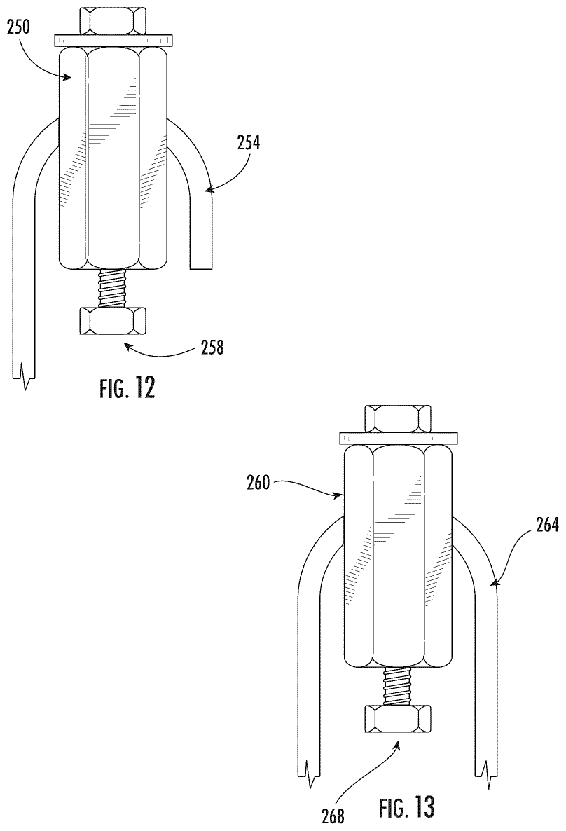

Referring to FIGS. 9-13, various aspects of apparatus 210 are provided. Apparatus 210 is configured to facilitate pulling one or more elongate structures, such as wires, through spaces, such as behind a dry wall and/or through a vent. Apparatus 210 is substantially the same as apparatus 110 except for the differences discussed herein.

Apparatus 210 includes a coupler 220, and a first leader 230. First leader 230 includes a first body 232 configured to receive a first flexible elongate structure, shown as first wire 238, a first pulling ring 240 configured to be coupled to the first body 232 and to detachably couple to the coupler 220, and a first fastener 242 configured to be coupled to the first body 232. The first fastener 242 is configured to interface against the first wire 238 to bias the first wire 238 from being removed from the first body 232 in a first direction 224 when the first body 232 is being pulled in a second direction 226 opposite the first direction 224. In various embodiments, the coupler 220 defines a loop 222, which is coupled to the first pulling ring 240, such as directly coupled.

In various embodiments, the first fastener 242 includes a helical thread 244. The first fastener 242 is inserted into an end 236 of the first body 232 along a longitudinal axis 234 of the first body 232. In various embodiments, an end 248 (shown schematically) of the first fastener 242 along a longitudinal axis 246 of the first fastener 242 interfaces against the first wire 238.

In various embodiments, apparatus 210 includes second leader 250 and third leader 260, which are structurally and functionally the same as first leader 230 except as otherwise noted.

Second leader 250 includes a second body configured to receive a second wire 254, and a second pulling ring configured to be coupled to the second body and detachably couple to the coupler, and a second fastener configured to be coupled to the second body. The second fastener is configured to interface against the second wire 254 to bias the second wire 254 from being removed from the second body in the first direction 224 when the second body is being pulled in the second direction 226.

Third leader 260 includes a third body configured to receive a third wire 264, and a third pulling ring configured to be coupled to the third body and detachably couple to the coupler, and a third fastener configured to be coupled to the third body. The third fastener is configured to interface against the third wire 264 to bias the third wire 264 from being removed from the third body in the first direction 224 when the third body is being pulled in the second direction 226.

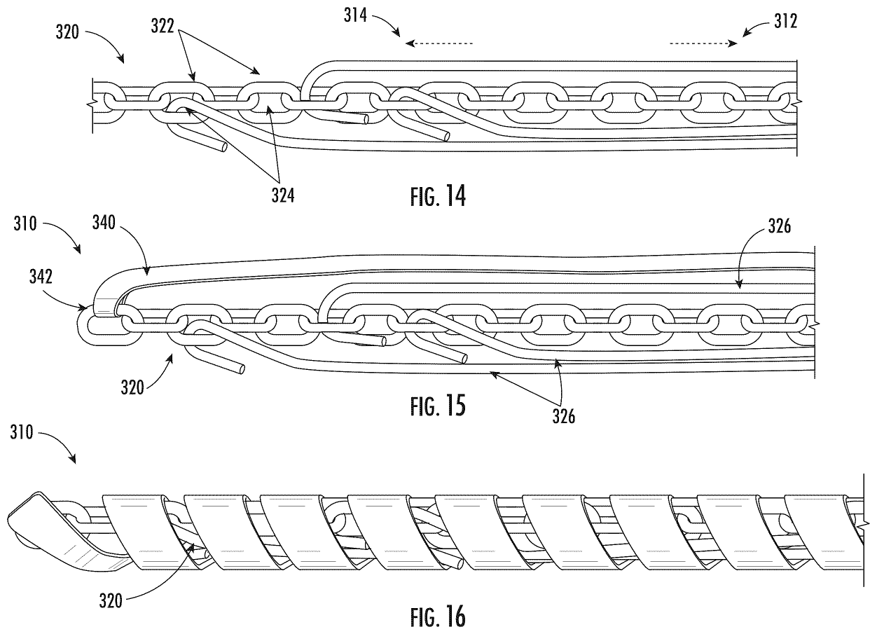

Referring to FIGS. 14-16, various aspects of apparatus 310 are provided. Apparatus 310 is configured to facilitate pulling one or more elongate structures, such as wires, through spaces, such as behind a dry wall and/or through a vent. Apparatus 310 is substantially the same as apparatus 110 or apparatus 210 except for the differences discussed herein.

Apparatus 310 includes a chain 320, and a flexible body 340. The chain 320 includes a plurality of links 322 coupled together. One or more of the plurality of links 322 define one or more apertures 324, the one or more apertures 324 configured to receive one or more flexible elongate structures, shown as wires 326, including a first wire 326. The flexible body 340 is configured to be circumferentially wrapped around the chain 320 a plurality of times. The flexible body 340 is configured to interface against the first wire 326 to bias the first wire 326 from being removed from the chain 320 in a first direction 312 when the chain 320 is being pulled in a second direction 314 opposite the first direction 312.

In various embodiments, the flexible body 340 includes a loop 342 that is coupled, such as directly coupled, to the chain 320. In various embodiments, the flexible body 340 is configured to be helically wrapped around the chain 320 the plurality of times.

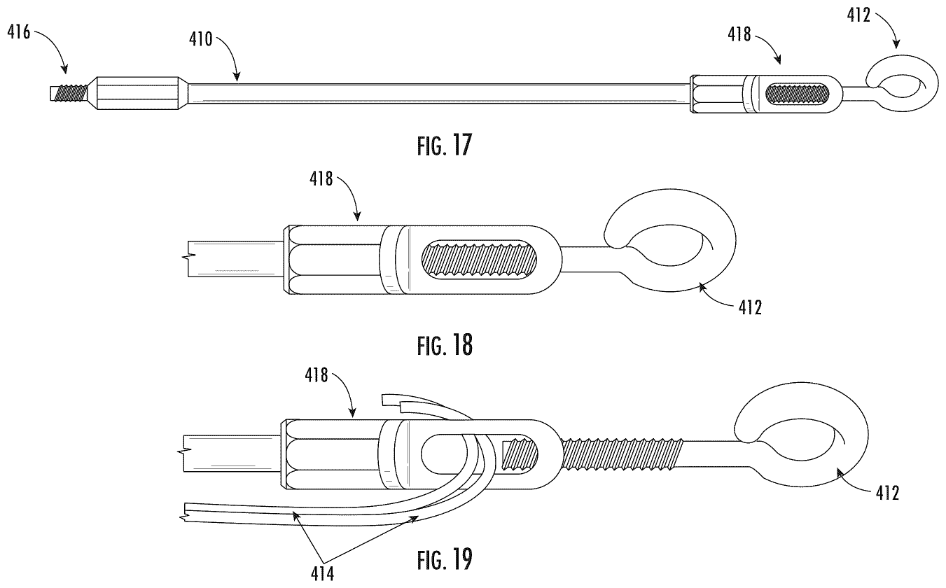

Referring to FIGS. 17-19, various aspects of apparatus 410 are provided. Apparatus 410 is configured to facilitate pulling one or more elongate structures, such as wires, through spaces, such as behind a dry wall and/or through a vent. Apparatus 410 is substantially the same as apparatus 110, apparatus 210, or apparatus 310 except for the differences discussed herein.

Apparatus 410 includes body 418, fastener 412 detachably coupled to body 418, such as via helical threads in each of body 418 and fastener 412, a fish tape 416 coupled to body 418, and one or more wires 414 configured to be coupled between fastener 412 and body 418.

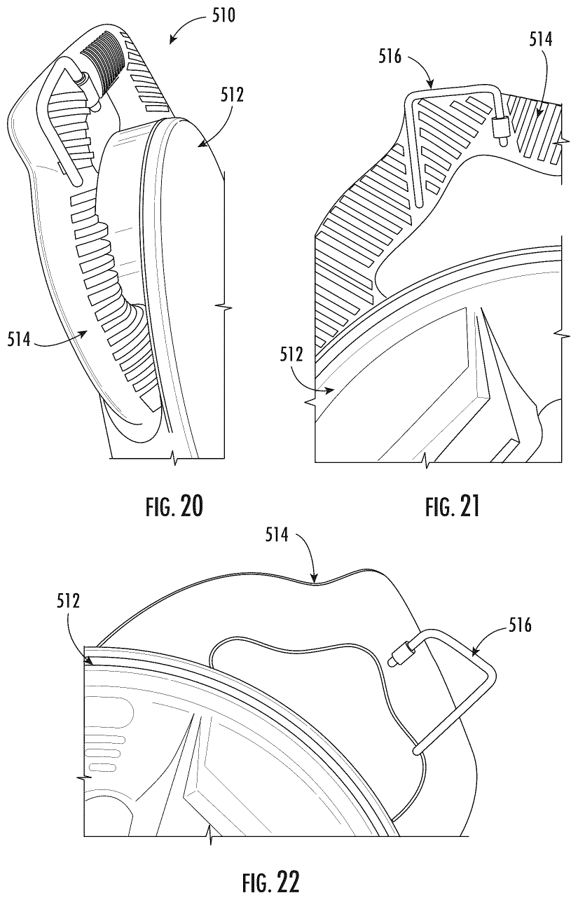

Referring to FIGS. 20-22, various aspects of apparatus 510 are provided. Apparatus 510 is configured to facilitate pulling one or more elongate structures, such as wires, through spaces, such as behind a dry wall and/or through a vent. Apparatus 510 is substantially the same as apparatus 110, apparatus 210, apparatus 310, or apparatus 410 except for the differences discussed herein.

Apparatus 510 includes body 512, handle 514 coupled to body 512, such as rigidly coupled, and a hook 516 pivotally coupled to one of body 512 or handle 514, such as being pivotally coupled to handle 514. In use, hook 516 can be pivoted away from handle 514 to support body 512 as fish tape is being extended from or retracted into body 512.

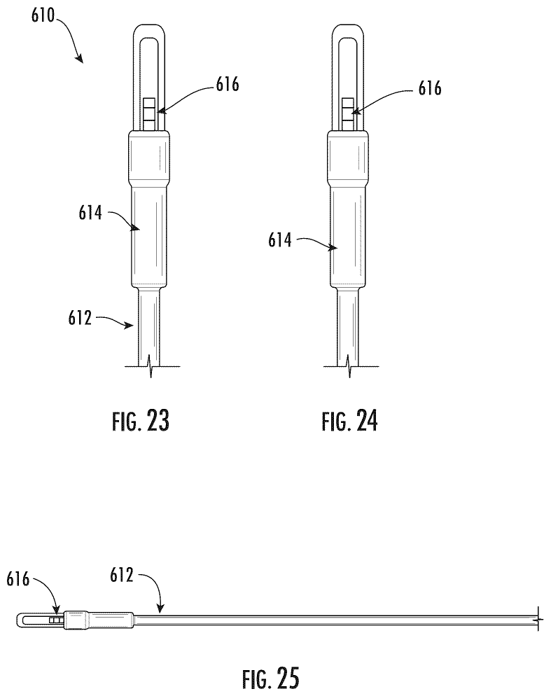

Referring to FIGS. 23-25, various aspects of apparatus 610 are provided. Apparatus 610 is configured to facilitate pulling one or more elongate structures, such as wires, through spaces, such as behind a dry wall and/or through a vent. Apparatus 610 is substantially the same as apparatus 110, apparatus 210, apparatus 310, apparatus 410, or apparatus 510 except for the differences discussed herein.

Apparatus 610 includes fish tape 612, and leader 614 coupled to fish tape 612. Leader 614 includes a light emitting element 616 configured to emit a light. In use, the light emitted by light emitting element 616 can be seen within a dark space that fish tape 612 is being sent through, thereby facilitating users grabbing leader 614 and/or moving leader 614 towards a desired location, such as an exit hole.

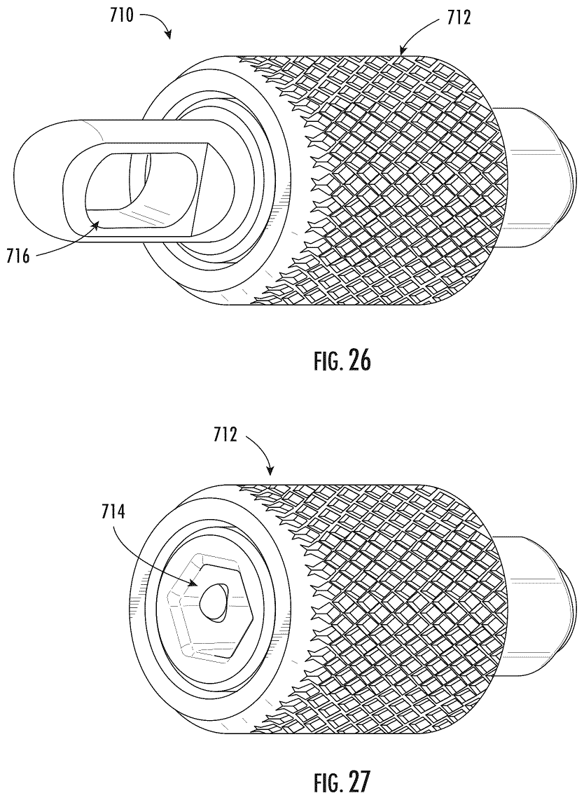

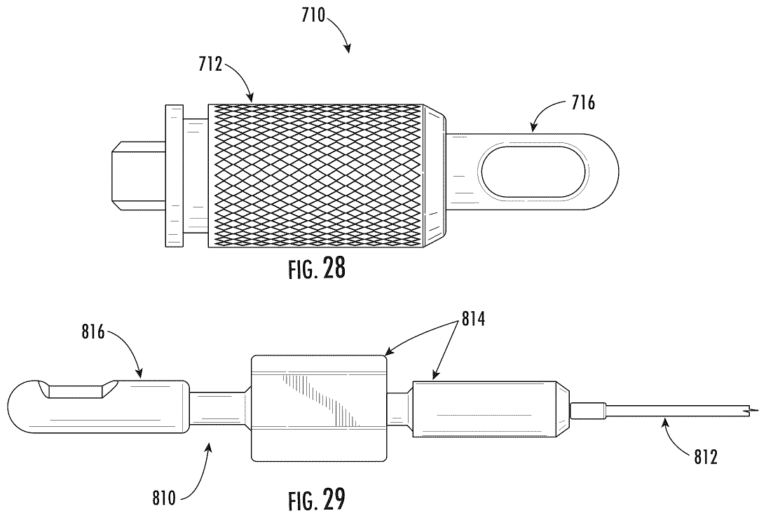

Referring to FIGS. 26-28, various aspects of apparatus 710 are provided. Apparatus 710 is configured to facilitate pulling one or more elongate structures, such as wires, through spaces, such as behind a dry wall and/or through a vent. Apparatus 710 is substantially the same as apparatus 110, apparatus 210, apparatus 310, apparatus 410, apparatus 510, or apparatus 610 except for the differences discussed herein.

Apparatus 710 includes body 712 that defines recess 714, and tip 716 that is detachably coupled to body 712 by being inserted into recess 714. In various embodiments, recess 714 defines six planar surfaces and a detent configured to bias tip 716 from being removed from recess 714. Applicant has observed that this structure for body 712 permits different tips 716 to be quickly coupled and decoupled from body 712, thereby facilitating the user customizing which tip to use for a given run.

Referring to FIG. 29, various aspects of apparatus 810 are provided. Apparatus 810 is configured to facilitate pulling one or more elongate structures, such as wires, through spaces, such as behind a dry wall and/or through a vent. Apparatus 810 is substantially the same as apparatus 110, apparatus 210, apparatus 310, apparatus 410, apparatus 510, apparatus 610, or apparatus 710 except for the differences discussed herein.

Apparatus 810 includes fish tape 812, leader 814, and tip 816. Tip 816 is detachably coupled to leader 814, thereby facilitating the user using different tips based on the type of run that the fish tape 812 is being extended through (e.g., bendy and/or long).

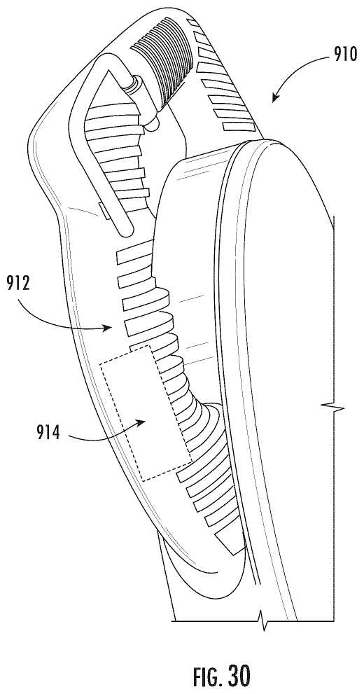

Referring to FIG. 30, various aspects of apparatus 910 are provided. Apparatus 910 is configured to facilitate pulling one or more elongate structures, such as wires, through spaces, such as behind a dry wall and/or through a vent. Apparatus 910 is substantially the same as apparatus 110, apparatus 210, apparatus 310, apparatus 410, apparatus 510, apparatus 610, apparatus 710, or apparatus 810 except for the differences discussed herein.

Apparatus 910 includes handle 912 and display 914 coupled to handle. In various embodiments display 914 digitally indicates, such as via emitting light, an amount of line that has been extended from the device that handle 912 is coupled to.

Additional details are shown and described in the accompanying figures.

It should be understood that the figures illustrate the exemplary embodiments in detail, and it should be understood that the present application is not limited to the details or methodology set forth in the description or illustrated in the figures. It should also be understood that the terminology is for description purposes only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one. As used herein, “rigidly coupled” refers to two components being coupled in a manner such that the components move together in a fixed positional relationship when acted upon by a force.

Various embodiments of the disclosure relate to any combination of any of the features, and any such combination of features may be claimed in this or future applications. Any of the features, elements or components of any of the exemplary embodiments discussed above may be utilized alone or in combination with any of the features, elements or components of any of the other embodiments discussed above.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. An apparatus for pulling multiple flexible elongate objects comprising:
a body extending along a longitudinal axis from a first end to a second end, the body defining an aperture extending through the body along the longitudinal axis;
a threaded fastener;
a threaded portion of the aperture comprising helical threads, the threaded portion configured to receive the threaded fastener that is received into the aperture at the second end of the body; and
a first recess of the aperture configured to receive a first flexible elongate structure that is received into the aperture at the first end of the body, the threaded fastener configured to interface against the first flexible elongate structure to bias the first flexible elongate structure from being removed from the body in a first direction when the body is being pulled in a second direction opposite the first direction.

2. The apparatus of claim 1, the threaded portion of the aperture defining a cylinder extending through the body along the longitudinal axis.

3. The apparatus of claim 2, wherein the cylinder is centrally located within the body.

4. The apparatus of claim 1, wherein the first recess is tapered in size such that a size of the first recess as measured perpendicularly to the longitudinal axis decreases the further the first recess is from the first end of the body.

5. The apparatus of claim 4, wherein the size of the first recess as measured perpendicularly to the longitudinal axis decreases linearly the further the first recess is from the first end of the body.

6. The apparatus of claim 1, comprising a second recess of the aperture configured to receive a second flexible elongate structure that is received into the aperture at the first end of the body, the threaded fastener configured to interface against the second flexible elongate structure to bias the second flexible elongate structure from being removed from the body in the first direction when the body is being pulled in the second direction.

7. The apparatus of claim 6, wherein the second recess is tapered in size such that a size of the second recess as measured perpendicularly to the longitudinal axis decreases linearly the further the second recess is from the first end of the body.

8. The apparatus of claim 6, comprising a third recess of the aperture configured to receive a third flexible elongate structure that is received into the aperture at the first end of the body, the threaded fastener configured to interface against the third flexible elongate structure to bias the third flexible elongate structure from being removed from the body in the first direction when the body is being pulled in the second direction.

9. The apparatus of claim 8, wherein the third recess is tapered in size such that a size of the third recess as measured perpendicularly to the longitudinal axis decreases linearly the further the third recess is from the first end of the body.

10. The apparatus of claim 9, wherein the first recess, the second recess, and the third recess are arranged symmetrically to each other with respect to the longitudinal axis.

11. An apparatus for pulling multiple flexible elongate objects comprising:
a coupler; and
a first leader comprising:
a first body configured to receive a first flexible elongate structure;
a first pulling ring configured to be coupled to the first body and detachably couple to the coupler; and
a first fastener configured to be coupled to the first body, wherein the first fastener is configured to interface against the first flexible elongate structure to bias the first flexible elongate structure from being removed from the first body in a first direction when the first body is being pulled in a second direction opposite the first direction.

12. The apparatus of claim 11, wherein the coupler defines a loop that is coupled to the first pulling ring.

13. The apparatus of claim 11, wherein the first fastener comprises a helical thread.

14. The apparatus of claim 11, wherein the first fastener is inserted into an end of the first body along a longitudinal axis of the first body.

15. The apparatus of claim 14, wherein an end of the first fastener along a longitudinal axis of the first fastener interfaces against the first flexible elongate structure.

16. The apparatus of claim 11, comprising a second leader comprising:
a second body configured to receive a second flexible elongate structure;
a second pulling ring configured to be coupled to the second body and detachably couple to the coupler; and
a second fastener configured to be coupled to the second body, wherein the second fastener is configured to interface against the second flexible elongate structure to bias the second flexible elongate structure from being removed from the second body in the first direction when the second body is being pulled in the second direction.

17. The apparatus of claim 16, comprising a third leader comprising:
a third body configured to receive a third flexible elongate structure;
a third pulling ring configured to be coupled to the third body and detachably couple to the coupler; and
a third fastener configured to be coupled to the third body, wherein the third fastener is configured to interface against the third flexible elongate structure to bias the third flexible elongate structure from being removed from the first body in the first direction when the third body is being pulled in the second direction.

18. An apparatus for pulling multiple flexible elongate objects comprising:
a chain comprising a plurality of links coupled together, one or more of the plurality of links defining one or more apertures, the one or more apertures configured to receive one or more flexible elongate structures including a first flexible elongate structure; and
a flexible body configured to be circumferentially wrapped around the chain a plurality of times, the flexible body configured to interface against the first flexible elongate structure to bias the first flexible elongate structure from being removed from the chain in a first direction when the chain is being pulled in a second direction opposite the first direction.

19. The apparatus of claim 18, the flexible body comprising a loop that is coupled to the chain.

20. The apparatus of claim 18, wherein the flexible body is configured to be helically wrapped around the chain the plurality of times.
